(19) United States
(12) Patent Application Publication
(10) Pub. No.: US 2013/0189391 A1
(43) Pub. Date: Jul. 25, 2013

(54) Dry Powdered Comestibles

(71) Applicant: Cole Alexander Egger, Dallas, TX (US)

(72) Inventor: Cole Alexander Egger, Dallas, TX (US)

(21) Appl. No.: 13/354,252

(22) Filed: Jan. 19, 2012

(51) Int. Cl. A23G 3/50; A23L 1/30; A23L 1/302; A23G 3/42; B65D 85/00

(52) U.S. Cl. 426/2; 426/115; 426/72

(57) ABSTRACT

A composition and method of use applicable to mitigate the effects of human fatigue that includes a base composition of at least one finely powdered simple sugar and at least one finely powdered polysaccharide, a flavoring, a hinder and a single dose packaging. The powdered composition is made available in a variety of flavors within a tubular package that aids in pouring the dry contents directly into the mouth without waste, where it is easily dissolved and assimilated by the body.

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### FIELD OF THE INVENTION

This invention relates generally to a dry powdered comestibles and methods therefor.

### BACKGROUND OF THE INVENTION

Various powdered comestibles, such as powdered candies are long known in the art. One such candy Pixy Stix®, has been produced since the 1950's. Fun Dip™ is a similar powdered candy sold in pouches. In the 19^{th} century “fizzy” powders were originated that produced an effervescent flavored beverage when placed in water. Such fizzy powders typically contained sugar, baking soda and citric acid. One of the sensations of the orally consumed powders is to produce a dry sour puckering sensation resulting from the citric acid. The foregoing, while adequate for their intended use, are not intended to be therapeutic in any way and provide merely a taste sensation. As candies, they are not intended to dissolve quickly in the mouth in order to assist in the assimilation thereof, but rather blended to linger in the mouth to produce the desired sensation.

Hypoglycemia, also colloquially termed “low blood sugar” is an abnormally diminished content of glucose in the blood. It can produce a variety of symptoms and effects but the principal problems arise from an inadequate supply of glucose to the brain, resulting in impairment of function (neuroglycopenia). Effects can range from mild dysphoria to more serious issues such as seizures. unconsciousness, and in rare circumstances, permanent brain damage or death. The most common forms of hypoglycemia occur as a complication of treatment of diabetes mellitus with insulin or oral medications. Hypoglycemia is less common in non-diabetic persons, but can occur at any age. Among the causes are excessive insulin produced in the body (hyperinsulinemia), inborn errors of metabolism, medications and poisons, alcohol, hormone deficiencies, prolonged starvation, alterations of metabolism associated with infection, and organ failure. Treatment of mild hypoglycemia involves restoring the blood glucose level to normal by the ingestion or administration of dextrose or carbohydrate foods.

Hypoglycemic symptoms and manifestations can be divided into those produced by the counter-regulatory hormones which can include nervousness, sweating or feeling of warmth, pallor, numbness, hunger and headache, among others, triggered by the falling glucose, and the neuroglycopenic effects produced by the reduced brain sugar which can include impaired judgment, irritability, fatigue, moodiness, depression and lethargy among others. In young children, vomiting can sometimes accompany morning hypoglycemia with ketosis. In older children and adults, moderately severe hypoglycemia can resemble mania, mental illness, drug intoxication, or drunkenness. In the elderly, hypoglycemia can produce focal stroke-like effects or a hard-to-define malaise. Frequently, the symptoms of a single person are similar from episode to episode, but may be influenced by the speed at which glucose levels are dropping.

Because the physical symptoms of the hypoglycemic state is frequently individualized, it is possible for hypoglycemic subjects to comprehend their own early-onset manifestations of the hypoglycemic state in order to circumvent more serious symptoms. Means traditionally used to correct for the hypoglycemic state by quickly raising blood glucose levels are glucose pills which are typically chewable, or edible glucose gel which may be absorbed quickly. Complaints regarding the texture of glucose pills and the messiness of glucose gel products remain an inhibitor of consumer acceptance, especially among children who unlike their parents, may not appreciate the serious consequences of failure to maintain normal glucose levels.

It is desirable to produce a dry powdered comestible that is of a composition that dissolves rapidly within the oral cavity, and promotes sufficient enzyme production, so that the composition is absorbed quickly into the bloodstream. More particularly, several bodily conditions such as fatigue, and/or malnutrition can be treated with an orally consumed dry powder which does not linger in the mouth, but dissolves, and is absorbed by the body for quick effect. It would desirable to provide such a product in a form that readily absorbs, is easily swallowed. is dose packaged, and travels well in a pocket, a lunchbox or a purse. It would also be desirable if the means and methods used for the forgoing product were applicable for the treatment of a hypoglycemic condition, and additionally, for use as energy boosters and dietary supplementation.

### SUMMARY OF THE INVENTION

Disclosed are embodiments according to the present invention that when taken into the mouth directly, and which under normal intraoral conditions require no added drink to dissolve and be absorbed by the body. Methods according to the present invention are used with dry powdered comestibles with and without vitamins for boosting energy levels. More particularly, the invention describes methods incorporating a dry finely powdered comestible contained in an easily opened tubular package. The comestibles, depending on the particular composition, when introduced directly into the mouth by way of the tubular packaging, are capable of inter alia, boosting energy levels, supplementing nutrition and maintaining normal glucose levels. Typically, the comestible is a dry powdered mixture having a base of at least one water soluble simple sugar and at least one polysaccharide to which various purpose-specific ingredients are added. and furthermore includes a method of use in which the complete dry composition is placed directly into the mouth for absorption without the requirement of added fluids. For placement directly into the mouth, the dry powdered composition must be of sufficiently small mesh size (mean aperture size) to dissolve quickly. However, because sugar and other polysaccharides are increasingly hygroscopic with increasing fineness, a means of producing more saliva is needed. This is accomplished with the addition of a “souring” ingredient, usually an organic acid such as citric or malic acid in sufficient proportion to mitigate the dryness caused by the fine powdered sugars.

In one aspect of the invention, an easily consumed glucose blood level corrective is supplied in a flavored and powdered form that quickly dissolves in the mouth. The corrective offers multiple advantages over previous oral means for correcting glucose levels, (1) the product will not cake, (2) is not messy like gel, (3) dissolves readily in the mouth (4) maintains flavor, (5) packs well in a lunchbox, (6) will not damage containers such as purses, by leakage (7) individual dose packaging eliminates confusion, (8) the composition does not have the appearance, texture or flavor of typical edible blood glucose correctives, and (9) the composition requires no refrigeration. Taken together, the unique attributes of the invention provide an oral means to control hypoglycemia that adults and especially children who tend to be self-conscious, will unhesitatingly use without fearing the stigma that is can be associated with previous products which have a “medicinal” appearance. The sugars are preferably a composition of powdered D-glucose and a glucose equivalent such as spray-dried maltodextrin which possesses amorphous sugar crystals that dissolve quickly in the mouth without requiring water. The powder is flavored with natural favoring which is an essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or any other edible portions of a plant, meat, seafood, poultry, eggs, dairy products, or fermentation products thereof, whose primary function in food is flavoring rather than nutritional. The powder preferably includes ascorbic acid for a vitamin C supplementation and to retard oxidation. Preferably, a binder and colorant such as beet root powder is included. The dry powdered mixture of D-glucose, maltodextrin and flavoring produces a base composition to which particular constituents can be added for different purposes, but sharing the common aspect of being introduced into the mouth directly in powdered form. An anti-caking ingredient such as silicon dioxide or calcium silicate can be added prior to packaging.

In another aspect of the invention, vitamins other than vitamin C (ascorbic acid) are introduced yielding a dry powdered dietary supplement that is introduced directly into the mouth.

In yet another aspect of the invention, energy boosting ingredients such as caffeine are introduced producing a dry powdered energy powder that is introduced directly into the mouth.

In still another aspect of the invention, fiber that is water soluble, or a combination of water soluble and non water soluble fiber is introduced.

### EXAMPLES

Other applications and uses for the invention will suggest themselves to those having skill in the related arts and benefit of this disclosure. Accordingly, the following details a variety of exemplary uses in accordance with the disclosed embodiments an is intended to be non-limiting.

### Base Composition

1) Obtain simple sugar powder (e.g., dextrose, galactose, fructose) corresponding to preferably a screen mesh size from #80 to #325, and most preferably at least #100 mesh;

2) obtain gluten-free spray derived maltodextrin powder with a dextrose equivalent (DE) between 5 and 20 corresponding to preferably a screen mesh size from #80 to #325, a most preferably at least #100 mesh; and,

3) mix ratio of simple sugar to Maltodextrin at least preferably 1:0.5, and still more preferably a range between (1:1-1:4).

4) add an acidic (sour to taste) component such as citric, malic, ascorbic acid, or any combination thereof.

### Hypoglycemic Corrective

1) Beginning with base composition, and using dextrose as the simple sugar constituent, add ascorbic acid, beet root powder and natural flavorings and mix in a drying (dehydrating) powder blender for at least 20 minutes; and,

2) package in single dose package including at least 9 grams of total carbohydrates to include at least 7 grams of sugar obtained from the D-glucose/Maltodextrin composition, or package in a single dose package including at least 4 grams of total carbohydrates to include at least 4 grams of sugar in the form of the D-glucose/Maltodextrin composition.

### Energy Booster

1) Beginning with base composition, add flavoring and energy boosting ingredients which are capable of passing through at least a #80 mesh screen which are taken from at least one of the following: ginseng, gotu kola, ginger, tumeric, maitake, MSM, DMAE, NADH, licorice root, black walnut, fennel, peppermint, and cayenne, rhodiola, DHA, EPA, ascorbic acid. B-vitamins, CO-Q10;

2) mix in a drying (dehydrating) powder blender for at least 20 minutes; and,

3) package in single dose package in dry powdered form.

### Vitamin Supplement

1) Beginning with base composition, add flavorings and ingredients which are capable of passing through at least an #80 mesh screen which are taken from at least one of the following: ginseng, gotu kola, ginger, tumeric, maitake, MSM, DMAE, NADH, licorice root, black walnut, fennel, peppermint, and cayenne, rhodiola, DHA, EPA, ascorbic acid, CO-Q10, B-vitamins, vitamin A, vitamin D, vitamin E, folic acid, biotin, panothenic acid, iodine, iron, magnesium, zinc, inositol, calcium, selenim, copper, manganese, chromium, molybdenum, potassium, boron, betaine HCl;

2) mix in a drying (dehydrating) powder blender for at least 20 minutes; and,

3) package in single dose package in dry powdered form.

### Dietary Fiber Supplement

1) Beginning with base composition, add flavorings and ingredients which are capable of passing through at least an #80 mesh screen which are taken from at least one of the following: soluble fiber, insoluble fiber;

2) mix in a drying (dehydrating) powder blender for at least 20 minutes; and,

3) package in single dose package in dry powdered form.

### Hypoglycemic Corrective Use Example

1) hypoglycemic condition is self detected by subject or detected by another,

2) hypoglycemic subject or another obtains dry powdered composition of the invention which includes:
(i) at least 4 grams of soluble carbohydrates in a dry powdered form,
(ii) powdered D-glucose,
(iii) at least one additional powdered dextrose equivalent,
(iv) flavoring, and,

3) tubular packaging containing the composition is opened, and the contents are poured directly into the mouth of the hypoglycemic subject by self administration, or administration by another.

4) monitoring of subsidence of hypoglycemic manifestations by subject or another, and additional action taken if required.

Regardless of the added flavorings and ingredients, the composition is placed directly in the mouth without the requirement of additional fluids. The composition dissolves readily with no unpleasant aftertaste.

While the invention has been described by the embodiments given, it is not intended to limit the scope of the invention to the particular form set forth, but on the contrary, it is intended to cover such alternatives, modifications, and equivalents as may be included within the spirit and scope of the invention as disclosed.

1. A method for dietary management to mitigate a condition of human fatigue among others, comprising the steps of:
1) providing a consumable single dose packaged dry powdered composition including at least one finely ground simple sugar with a mean aperture of #80 to #325 mesh equivalent, and at least one polysaccharide with a mean aperture of #80 to #325 mesh equivalent, at least one flavoring agent, and at least one organic acid, and
2) tearing the single dose package and pouring the contents directly into the mouth for dissolving therein.

2. The method of claim 1, in which the at least one simple sugar is taken from at least one of the following: dextrose. galactose, fructose.

3. The method of claim 1, in which the packaging is generally tubular.

4. The method of claim 1, in which the polysaccharide includes maltodextrin.

5. A method for dietary management of healthy glucose levels including the steps of:
1) providing a consumable single dose packaged dry powdered composition of at least 5 grams total weight to include at least 4 grams of total carbohydrates including at least 3 grams of sugars, comprising:
(i) powdered D-glucose passable through at least #40 mesh,
(ii) at least one dextrose equivalent passable through at least #40 mesh,
(iii) at least one binder,
(iv) at least one flavoring,
(v) at least one food coloring, and,
2) tearing the packaging and administering the corrective intraorally by pouring directly into mouth whereupon it dissolves.

6. A powdered composition to mitigate a condition of human fatigue, among others, comprising:
1) at least one dry finely powdered simple sugar,
2) at least one dry finely powdered organic acid,
3) a tubular package sized to be inserted at one end into a mouth,
4) at least one flavoring agent.

7. The powdered composition of claim 6 in which the at least one simple sugar is selected from at least one of the following: fructose, d-glucose, galactose.

8. The powdered composition of claim 6 in which the at least one organic acid is selected from at least one of the following: citric acid, malic acid, ascorbic acid.

9. The powdered composition of claim 6 further comprising at least one vitamin.

10. The powdered composition of claim 6 further comprising an energy boosting ingredient.
